(19) United States
(12) Patent Application Publication
(10) Pub. No.: US 2002/0052929 A1
(43) Pub. Date: May 2, 2002

(54) Method, apparatus and system for electronic advertising and managing information on the internet

(76) Inventors: John David Walker, Melbourne, FL (US); Dennis Deruelle, Melbourne, FL (US); Gilbert Russell, Melbourne, FL (US); Brian Wetzel, Melbourne, FL (US); Timothy Yandell, Melbourne, FL (US)

Correspondence Address: David P. Lhota, Stearns Weaver Miller, Suite 1900, 200 East Broward Boulevard, Fort Lauderdale, FL, 33301, US

(21) Appl. No.: 09/871,008

(22) Filed: May 31, 2001

Related U.S. Application Data
(60) Provisional application No. 60/208,113, filed on May 31, 2000.

(51) Int. Cl. G06F 15/173; G06F 15/16

(52) U.S. Cl. 709/218; 709/223

(57) ABSTRACT

Software that manages and controls auxiliary browsers based on user inputs, related information and/or links on the Internet, and more particularly, a browser plug-in software that accesses correlating links or websites based on user inputs, manages and controls the location of auxiliary browsers, such as browsers that display banner advertisements on a host website, links to secondary Internet addresses available in the banner browser, and provides simultaneous viewing of information at the secondary Internet address and information related to the banner and its links in the auxiliary browser.

### CROSS REFERENCE TO RELATED APPLICATIONS

This application claims the benefit of provisional application Ser. No. 60/208,113 filed May 31,2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to software that manages and controls auxiliary browsers based on user inputs, related information and/or links on the Internet, and more particularly, to browser plug-in software that accesses correlating links or websites based on user inputs, manages and controls the location of auxiliary browsers, such as browsers that display banner advertisements on a host website, links to secondary Internet addresses available in the banner browser, and provides simultaneous viewing of information at the secondary Internet address and information related to the banner and its links in the auxiliary browser.

2. Description of the Background Art

Banner advertising is becoming increasingly prevalent on the Internet and provides a source of revenue for website owners. Banner advertisements are displayed in auxiliary browsers that are located in a predetermined segment of a host website page, and typically provide links to corresponding websites. Banner advertising, however, as become largely ineffective for several reasons. Banners are frequently ignored because of the auxiliary browser has visually poor positioning and are normally static or fixed on the web page. Auxiliary browsers, also referenced herein as banner browsers or banners, are often located at the top of a web page such that they scroll with the main screen. As a result, the reader's eyes quickly drop down to the usable text on the web page and effectively sublimate the banner browser. Alternatively, banners are placed at the bottom of the web page. Readers typically stop scrolling at the point where the banner browser begins and ignore the rest of the page containing the banner. Some banner browsers include rotating banners that advertise for multiple companies. However, the opportunity to click a particular banner of interest and exit to the page referenced by the banner frequently passes before the observer has a chance to respond. Finally, responding to a banner advertisement necessitates exiting from the host web site where the banner is displayed and going to a different web site, thus disrupting the flow of information that brought the user to the site in the first place.

Several devices and systems for presenting advertising over the World Wide Web are known in the background art. However, none of these addresses or solves the above-noted problems associated with current banner advertising on the Internet. The patent references found fail to disclose important structural elements of the instant invention. For instance, U.S. Pat. No. 6,009,410 discloses a customized advertising repository server in which a user can access their customized advertisement. The user consults with the database to produce a personal ad page, which may contain multiple static images, streaming banners, 3D images, animation, video and/or audio clips. A warehouse of different subscribing advertisers and their associated advertisements may be accessed to assist the user in creating an advertisement. U.S. Pat. No. 5,917,491 discloses a page proxy that manages the representation of page information on the web by using bookmarks within a browser and providing information to users on organizing and categorizing their bookmarks. U.S. Pat. No. 5,742,768 discloses a system and method for providing and displaying a web page having an imbedded menu. The imbedded menu provides a user of a web browser with a plurality of links through one action in the displayed web page. U.S. Pat. No. 5,937,392 discloses an Internet advertising system comprising a database, a controller and an ad server operating as part of a web server. The ad server controls the relative ratios of serving ads, the distribution of ads throughout the day and triggering mechanisms for controlling the ads served. U.S. Pat. No. 6,014,698 discloses a system for storing and delivering information on a computer network, specifically the storage, delivery and tailoring of advertising information, including accurate accounts of the number of times the information is displayed or served to users. U.S. Pat. No. 6,011,537 discloses an apparatus and method for delivering and displaying secondary information on a monitor, wherein the secondary information is not displayed until the user activates a display command or until the user is finished with primary information. The information is categorized according to primary information and secondary information and there is a delay period between the request time and the time in which primary information and secondary information is retrieved and made available. U.S. Pat. No. 5,918,014 discloses an automated advertising filter that can show different ads to different people who are simultaneously viewing the same content. The system tracks activities of its visitors, derives information therefrom, and categorizes people into different communities.

The above noted prior art fails to provide a method, device or system that addresses the foregoing needs for improved banner browser placement visibility and accessibility without disruption. As the foregoing prior art fails to enhance banner browser advertising exposure and accessibility without disrupting primary Internet activity, there exist a need for a method, apparatus and/or system that enhances Internet advertising and information access over the Internet. The instant invention addresses these gaps in the prior art by providing flexibility in banner browser positioning, allowing a user to view linked websites without losing connection to the host website, and compiling, managing and providing information related to the linked websites in a virtually seamless, user-friendly format.

### BRIEF SUMMARY OF THE INVENTION

Based on the foregoing, it is a primary object of the instant invention to provide a software based apparatus and system that enhances Internet advertising and related information access over the Internet.

It is an object of the instant invention to provide a software based apparatus, system and method that controls and changes banner displays based on user inputs into their computer, laptop computer, or other microprocessor based systems, such as EMR systems and Palm Pilots.

It is another object of the instant invention to provide a software based apparatus, system and method that can provide patient related information related to current diagnosis, prescriptions, medical conditions, medical history, available drugs, candidates for clinical trials and/or medical devices.

It is another object of the instant invention to provide a software based apparatus, system and method having a banner browser that is driven, controlled and changed by user inputs.

It is also an object of the instant invention to provide a software based apparatus and system that controls and manages banner browsers, banner advertisements and/or related information appearing in and accessible through auxiliary browsers, in a manner that provides more flexibility in positioning, accessing and using the information contained therein.

It is another object of the instant invention to provide a software based apparatus or system for managing banner browser and/or related information that is operable on a desk top computer, lap top computer, Internet terminal, slate computer and/or other portable microprocessor based unit having Internet communication capabilities.

It is an additional object of the instant invention to provide a software based apparatus or system for managing banner browser or related information that is compatible with existing software on a computer.

It is yet another object of the instant invention to provide a software based auxiliary browser management system or apparatus that facilitates simultaneous viewing of the host website and secondary websites accessible through the auxiliary browser.

It is yet an additional object of the instant invention to provide a software based auxiliary browser management system or apparatus that facilitates delayed viewing of secondary websites accessible through secondary browser hot spots.

It is yet a further object of the instant invention to provide a software based auxiliary browser management system or apparatus that provides summarized or pre-selected information regarding an auxiliary website accessed through the secondary browser to allow a user to make an informed decision on visiting the secondary websites.

It is still an object of the instant invention to provide a software based secondary browser management system or apparatus that compiles information regarding auxiliary websites to facilitate delayed visits to said website.

In light of these and other objects, the instant invention generally teaches a method, apparatus and software based system for controlling and managing the content and display of auxiliary browsers, such as banner advertisements, or similar informational windows or auxiliary segments on a website based on user inputs. The invention may be described as a browser controller that resides in a host website, auxiliary browser or a user's microprocessor based unit or system. The browser controller manages banner content, retrieval and display based on predetermined parameters, which are preferably driven by user inputs meeting certain conditions, or other actions, such as those based on received e mail, trigger dates and the like. For instance, when a physician or physician's assistant enters inputs into a microprocessor based unit or system, such as those disclosed herein, the invention retrieves and displays in the banner predetermined and related information corresponding to the user input, such as patient history, conditions, prescriptions, available drugs and alternative drug provides, clinical trial candidates and/or other related information. If the invention is employed for other industries, then user inputs into a portable or fixed microprocessor based unit would retrieve and display banner advertisements and/or information correlating to the input. Although the invention is primarily described in reference to banner advertisements, it may be employed with any auxiliary browser in a website containing third party information and hot spots/links to related URL addresses, i.e. auxiliary websites. The program can be tailored for use by consumers wherein the software would reside on their processor based unit and display banner advertisements or information based on inputs such as Internet search inquires, subject matter of inputs or other information correlating to the user inputs.

The instant invention comprises an information/banner browser plug-in device and/or system that controls the location of auxiliary browsers and/or similar windows, facilitates simultaneous viewing of the host website and auxiliary websites accessed through the auxiliary browser, provides abstracts or brief information regarding the auxiliary websites, allows users to defer viewing of the auxiliary websites for a later time and compiles and manages a list of deferred auxiliary websites. The banner browser plug in may be loaded and run from any computer operating system in the art such as Microsoft. The instant invention communicates with and may also provide at least one auxiliary/pop-up window or the ability to create pop-up windows adapted for linking to secondary URL websites/addresses. The banner browser plug-in configuration of the invention is compatible with existing operating systems, microprocessors and application software, and complements the software features commonly available in a windows-type environment. To accomplish the objectives and features noted herein, the invention is configured in a browser plug-in device and/or system that provides flexibility in controlling the location of banner browser or other auxiliary windows and managing secondary URL addresses. The invention utilizes software comprising processor readable code stored on a tangible memory device, such as a compact disc, tape, floppy disc, hard drive, computer chip or similarly known medium, that is operable by any desk top computer, lap top computer, internet terminal, slate computer and/or other processor based unit.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1A is a system view of the preferred embodiment of the banner browser system of the instant invention.

FIG. 1B is a system view of the preferred embodiment of the banner browser system of the instant invention.

FIGS. 2A-E are flow chart diagrams of the banner browser system and software logic of the instant invention.

FIG. 3 is a flow chart diagram of another embodiment of the banner browser system and software logic of the instant invention.

FIG. 4A is a pictorial illustration of the host website page in a first position in relation to the auxiliary banner browser in accordance with the preferred embodiment of the instant invention.

FIG. 4B is a pictorial illustration of the host website page in a second position in relation to the auxiliary banner browser in accordance with the preferred embodiment of the instant invention.

### DETAILED DESCRIPTION OF THE INVENTION

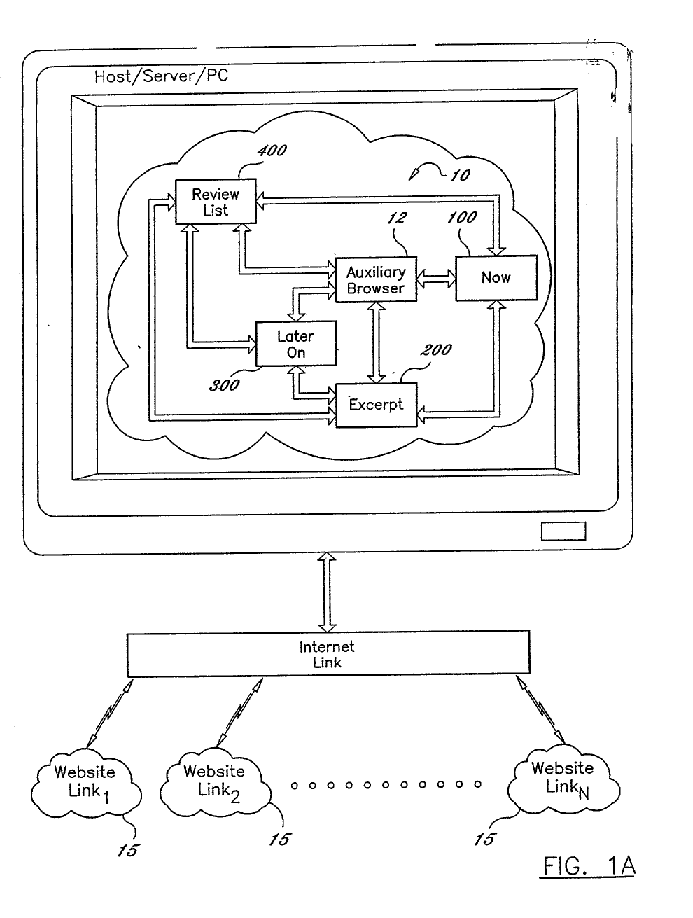

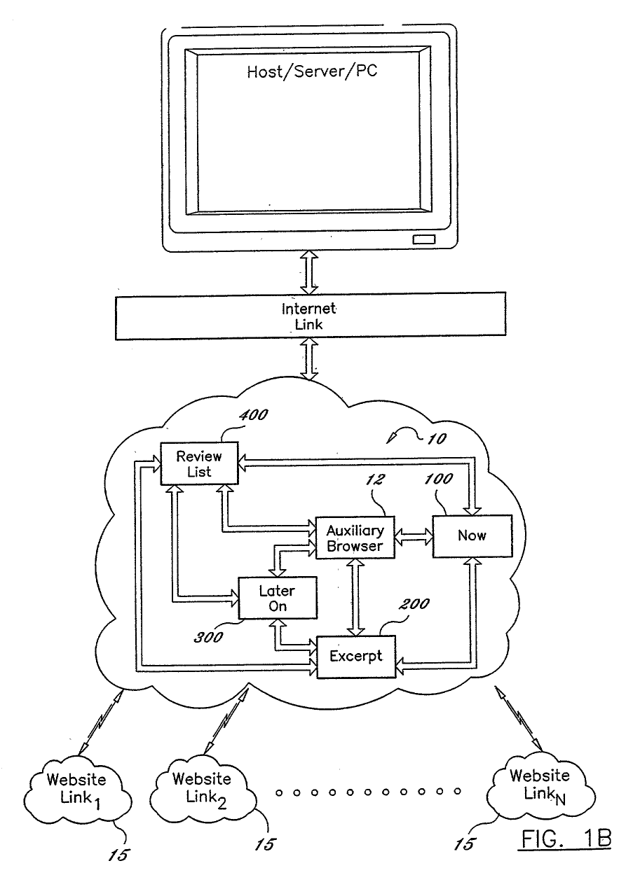

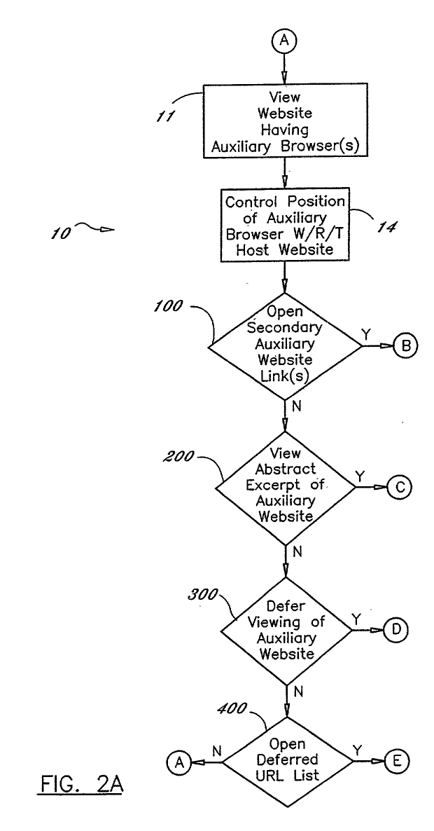

With reference to the drawings, FIGS. 1A-4B depict the preferred and alternative embodiments of the instant invention that is generally characterized or referred to as a banner browser controller and/or by reference numeral 10. Referring to FIGS. 1-4B, the banner browser controller 10 of the instant invention comprises a software based apparatus, method and system for controlling and managing banner browsers and related information based on user inputs in a microprocessor based unit, such as a fixed or portable computer, slate computer and the like. The banner browser controller 10 is a browser plug-in device that may be loaded into and processed from any conventional computer system to monitor, manage, create and control auxiliary browsers and their hot links. As the banner browser controller 10 comprises a browser plug-in device, the instant invention 10 can control and manage the position and content of auxiliary browsers on a host website page, scroll the host website page independent of and without affecting the positioning of the auxiliary browser on the host website page, simultaneously display the host website and an auxiliary website, and read, store, create and process information pertaining to the auxiliary browser and its hot links using a software program 100-400 developed in accordance with the instant invention. The banner browser controller 10 comprises a software program of processor readable instructions 100-400 stored or storable on a processor compatible and readable medium, such as a hard drive, diskette, compact disc, computer chip, tape or other digital storage means. The banner browser controller 10 may reside on or be downloaded for use on end-users' computers or the host website computers.

With reference to FIGS. 1A and 1B, the instant invention 10 comprises a software program 100-400 that may be stored and processed from an end-user's computer, an advertising parties' computer or server 11, or a host website owner's computer or server 13 and an auxiliary browser 12 for controlling and displaying the banner. The software of the invention preferably includes a view or process “now” routine 100, an “excerpt” retrieval and viewing routine 200, a view “later on” routine 300 and a “review list” routine 400. The software may be written in a Java based language or any other available language compatible with existing architecture. A preferred computer 11 or 12 should have a minimum of a 200 MHz processor, 32 megabytes of RAM, a DOS, Microsoft or compatible operating system and means for connecting to and communicating with the Internet, such as a modem, cable modem, T1 or other known device. Referring to FIGS. 1A and 1B, the banner browser controller 10 may be made available for download onto any computer system 11. The banner browser controller 10 may reside on or be downloaded for use on end-users' computers 11 or the host website computer 13. Referring to FIG. 1A, the software program 100-400 may be stored on and processed from an end-user's computer 11, such as a third party consumer, for accessing, uploading and/or displaying website links 15 available on a globally accessible network 50, such as the world wide web or Internet 50, based on user inputs and predetermined parameters. The end-user can load and ran the software program 100-400 as a separate browser, interface with the Internet through the software program 100-400, compile and store URL related information in a designated and accessible section of a predetermined database in the end-user's computer and utilize the various features of the instant invention. Referring to FIG. 1B, the software program 100-400 may alternatively be stored on a website host or advertising parties' computer or server 13 such that the end-user accesses the program by first establishing an Internet connection and going to a central website or coming across a website that makes the software program 100-400. Regardless of the operating computer running the software program 100-400, the instant invention 10 can select and communicate with any database to store, create, access, categorize and/or edit URL related information compiled and stored in the database using the software program 100-400.

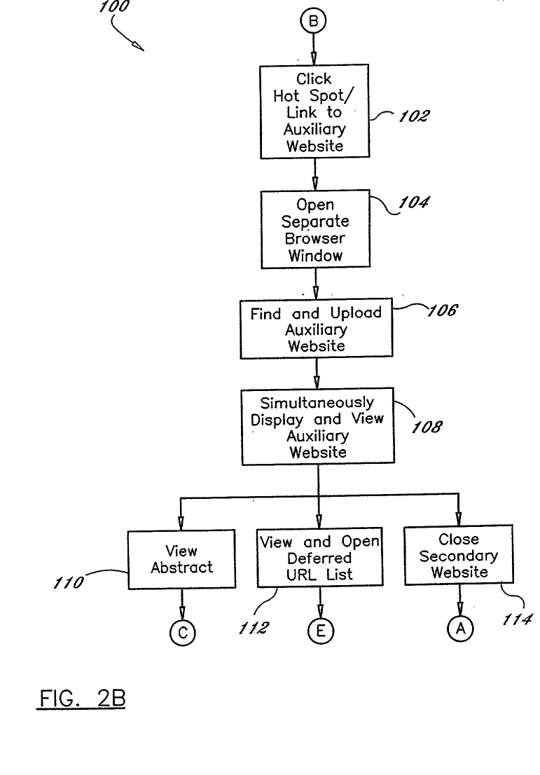

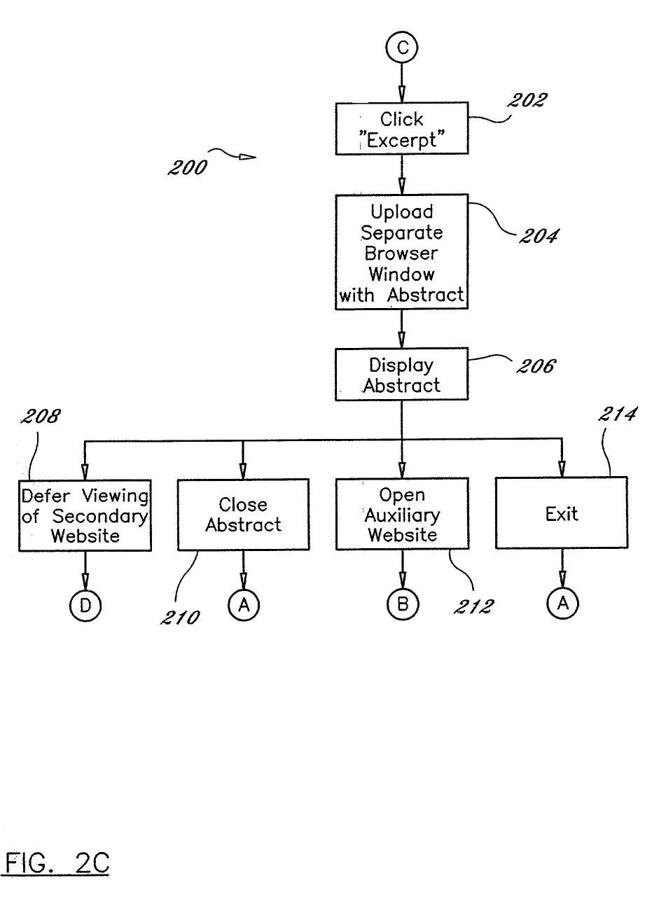

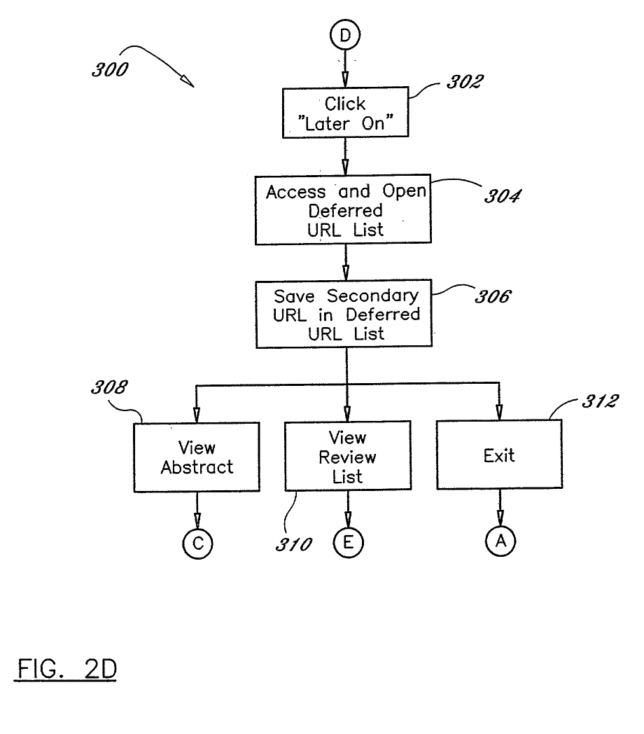

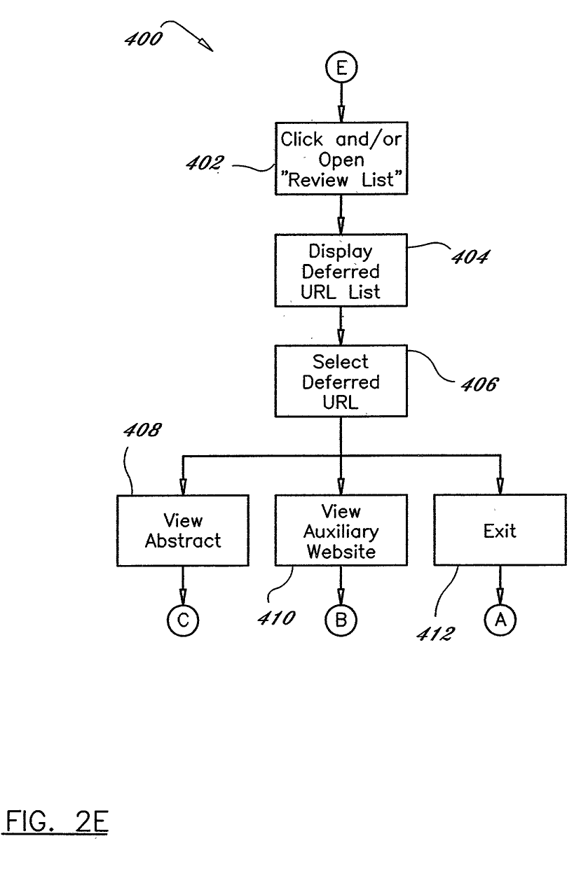

The software program 100-400 comprises a plurality of sets of processor readable instructions in the form of code for reading, ascertaining, storing and processing URL information to allow a user to immediately visit related websites through the “now” routine 100, defer viewing of related websites with the “later-on” routine 300, create and access abstracts regarding related websites with the “excerpt” routine 200 or create a review list of deferred and/or favorite websites with the “review list” routine 400. With reference to FIGS. 2A-2E, the processor readable instructions 100-400 include at least one routine or means for immediate viewing of the auxiliary website(s) 100, at least one routine or means for creating, supplying and/or displaying an abstract, at least one routine or means for provideing an excerpt or other summary description of the auxiliary website(s) 200, at least one routine or means for delayed viewing of the auxiliary website(s) 300, and at least one routine or means for creating, editing and/or displaying a deferred or favorites auxiliary website list 400, as more fully described herein. The banner browser controller 10 can perform its various functions with one to two execute commands, i.e. clicks or inputs. The banner browser controller 10 may be stored and processed from an end-user's computer 11, a host website's server/computer or an auxiliary server/computer 13. URL addresses associated with auxiliary websites are determined, categorized and stored into preselected databases in predetermined positions.

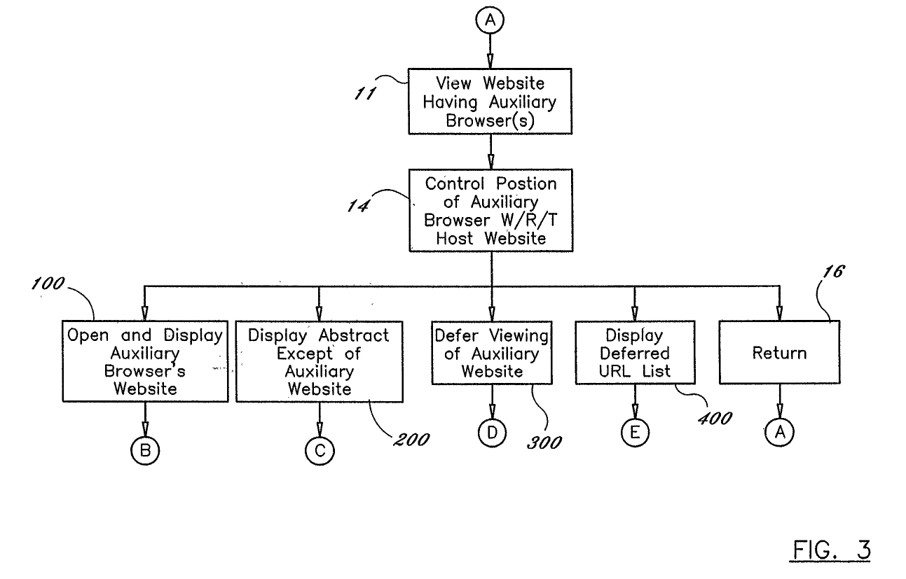

With reference to FIGS. 3 and 2A-E, the software 100-400 is shown. The software 100-400 comprises the flow of steps generally shown in these figures. The user has the option of accessing and running any of the routines 100-400 to visit or defer visits and links as described herein.

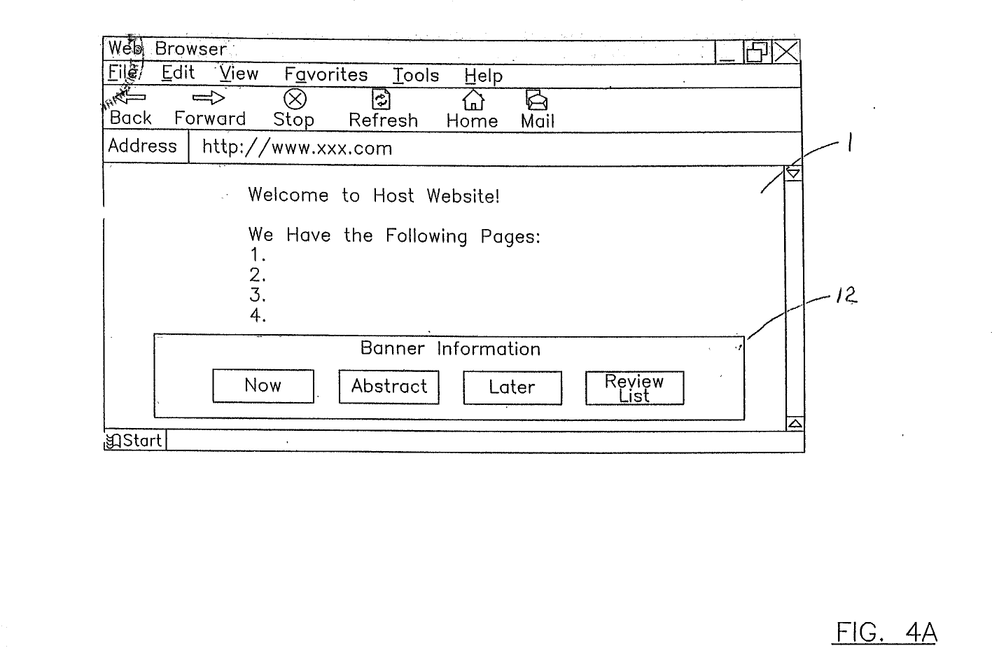

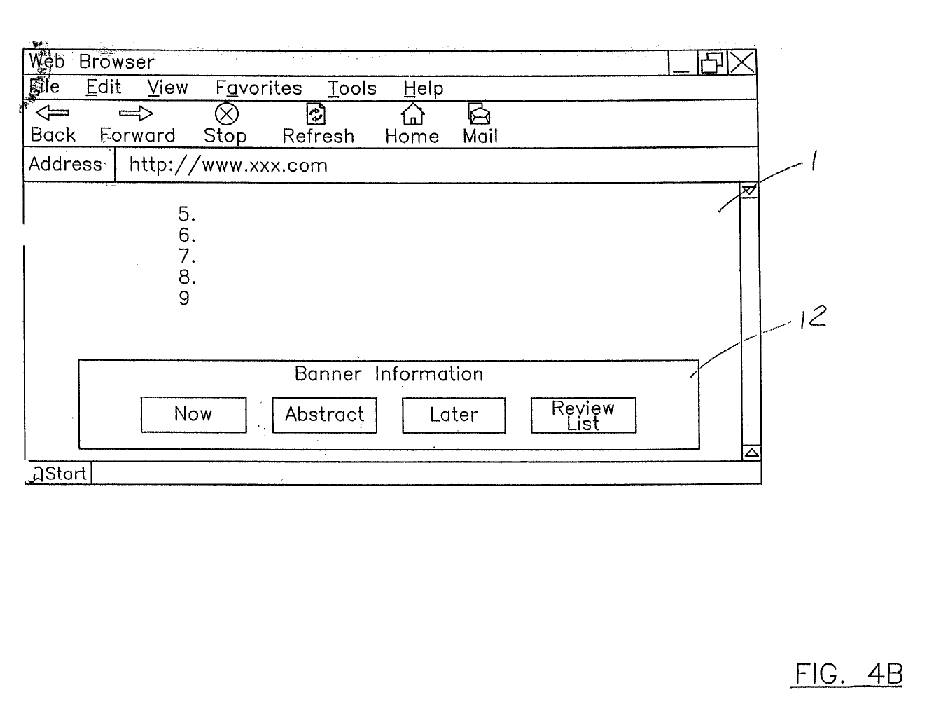

With reference to FIGS. 4A-B, the instant invention 10 includes software code or objects that independently position the auxiliary browser 12 over the primary/host web-page in a manner that allows the host web page(s) to be scrolled independent of the auxiliary browser. Accordingly, the host web page(s) may be scrolled without affecting the positioning of the banner. Referring to FIG. 4A, the auxiliary browser 12 is preferably positioned at the bottom of the main page 1, but may alternatively be placed at the top of the page or in any other designated position. As the banner browser controller 10 preferably comprises a browser plug-in, the invention can control the banner browser 12 location at all times. When the banner browser position is fixed at the bottom of the host web page 1 the banner is easily visible and does not obstruct the viewing of the main web page. Since it occupies a fixed area of real estate at the base of each page, it eliminates the “scroll-down” issue present in the prior art and the banner segment information and links are always conveniently visible and available. In addition, when the banner segment is located at the base of a web page, the user's eyes are drawn directly to the margin above the banner segment as the page is scrolling down thereby making it more likely to be seen. While this does not mean that the banner will not be ignored it does mean that the information is always there and typically will be seen at the completion of reviewing the information on the main page.

Referring to FIGS. 2A-3, the browser controller 10 adds several unique features to the functionality of the invention, as above noted. For instance, the invention includes a “now” button, which comprises a hot spot within the banner that initiates and runs the now routine 100 allows a user to immediately click on the banner link to access the web site referenced by the banner without losing convenient access or connection to the host or main website page. While linking to other websites from another website is not new, the invention teaches a different approach that accesses and links to websites 15, or similarly available links, based on user inputs and displays the new web page over the current web page in the auxiliary or separate browser window 12, such that the user is not forced to exit form the web site they are currently browsing. This is a far more preferable approach than exiting the web site 1 to a second page based on a banner click.

Another feature of the instant invention 10 comprises an “excerpt” button and routine 200 that accesses abstracts or summaries of various links from a predetermined database and displays the list of abstracts or the selected abstract of the web page links highlighted and/or referenced by the banner in the auxiliary browser window 12. The excerpt routine 200 allows the user to determine whether they wish to interrupt their current action to visit the web site referenced by the abstract, defer that visit (see “later-on” function below) or close the abstract window and return to the page they were previously viewing. The excerpt routine 200 can provide immediate viewing of the link abstract without interrupting current inputs and activity, since the data for the referenced link is already contained and accessible in an array within the plug-in and/or database, thereby limiting any latency inherent in a banner click. The later-on routine 300 of the banner browser controller 10 defers links to correlating web sites identified by the user input to a later time. The later-on routine 300 creates and stores a list of deferred destinations in a plug-in device or database and so that the user can access suggested sites or links at a later date. This routine 300 is accessed and triggered by clicking a “later-on” button as the banner is displayed or in the excerpt window. In both places the effect will be the same.

The invention 10 includes a review list routine 400 for creating, storing and accessing a list of websites or links for visiting at a later date or anytime. This routine 400 brings up a list of the deferred URLs and a link to the “excerpt” abstracts and routines 200 for each of the deferred pages. If the user wants to visit any of the websites or links identified in the review list they click on the URL of the referenced web site or link in the review list to instantly upload and/or link to that web site through the auxiliary browser 12, which may pop-up over the window which displays the deferred list.

It is intended that the banner browser plug-in of the instant invention 10 will be installed as a plug-in component into both Internet Explorer from Microsoft, Netscape's navigator and other browser programs. As a plug-in it becomes invulnerable to any third party software and web site issues which appear above it. In fact, it operates independently of any software generated by a web site.

Multiple positions and auxiliary browsers 12 are available in an alternative embodiment. In other words, each position may have an unlimited number of banners rotating within each position on that page 1. This would mean that a prospective advertiser could purchase one center banner, on top left banner and a bottom right banner and these would appear at random intervals during the presentation. Finally, the software which serves the banner advertising into the banner browser plug-in 10 may run from a central server database and will, at scheduled intervals, load new data (banner images, URLs and excerpts) into the plug-in's data array area or database and also download usage information generated by the previous set of data. This will allow us to track exposures, click-through and excerpt viewings for delivery to advertisers as statistical and demographic information.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A browser controller for controlling, managing and accessing secondary websites and links comprising:
processor readable set of instructions;
means for receiving user inputs that are processed by said instructions;
means for controlling and displaying content in an auxiliary browser based on user inputs, wherein content comprises website URL links and information related thereto available on a globally accessible network;
means for correlating user inputs with said content for selecting, retrieving and displaying said content; and
means for controlling the timing of linking to said URL links and viewing said content.

2. A controller as recited in claim 1, further comprising a database for storing and retrieving URL and content related information.

3. A controller as recited in claim 1, further comprising a review list routine, a now feature routine, an excerpt routine and a later on routine for controlling when a link is made.
